(19) United States
(12) Patent Application Publication
(10) Pub. No.: US 2014/0085876 A1
(43) Pub. Date: Mar. 27, 2014

(54) HANDHELD WORK LIGHT INCLUDING ADJUSTABLE LIGHT FOCUSING OR SCATTERING MECHANISM

(71) Applicants: Marc Howard Fields, Kingwood, TX (US); Li Dong Xie, Ningbo (CN)

(72) Inventors: Marc Howard Fields, Kingwood, TX (US); Li Dong Xie, Ningbo (CN)

(21) Appl. No.: 13/868,835

(22) Filed: Apr. 23, 2013

(30) Foreign Application Priority Data
Apr. 3, 2012 (CN) 201230125321.6
Apr. 23, 2012 (CN) 201230125280.0
May 3, 2012 (CN) 201220194835.1

(51) Int. Cl. F21L 4/00; F21L 14/02

(52) U.S. Cl. CPC F21L 4/00; F21L 14/02
USPC 362/187; 362/228

(57) ABSTRACT

In accordance with various embodiments, there is provided a work light, which includes a housing, a light source including one of a light-emitting diode and a compact fluorescent light, and a light assembly including a plurality of light-emitting diodes. The work light further includes a power source, and a light focusing mechanism including a slide switch. The slide switch controls a focus distance of light emitted from the light source. The light focusing mechanism is configured to focus light emitted from the light source, when the slide switch is positioned in a first position, and configured to scatter light emitted from the light source, when the slide switch is positioned in a second position.

### RELATED APPLICATION

This application claims the benefit of and priority to (1) Chinese Patent Application No. 201220194835.1, filed on May 3, 2012, now Chinese Utility Model Patent No. CN202660275U, issued on Jan. 9, 2013, (2) Chinese Patent Application No. 201230125280.0, filed on Apr. 23, 2012, and (3) Chinese Patent Application No. 201230125321.6, filed on Apr. 23, 2012, all of which are incorporated herein in its entirety.

### BACKGROUND

1. Field of the Invention

Embodiments of the invention generally relate to a work light, and more particularly, to a work light including a light focusing mechanism for focusing or scattering light emitted from the work light, whereby the light focusing mechanism includes a slide switch.

2. Description of the Related Art

Conventional work lights have varying designs and functions according to their application of use. A conventional handheld work light includes, for example, a lamp housing, a power source, for example, a battery, contained in the lamp housing, and a light source. One distal end of the lamp housing includes a transparent cover. The power source is contained in the lamp housing near the other distal end thereof. In operation, the light source emits light through the transparent cover of the lamp housing. Although it is convenient to use, this type of conventional handheld work light has a simple structure, and therefore fails to provide a mechanism for adjusting the focus distance of the light emitted from the light.

Some conventional handheld work lights include a light focusing mechanism for focusing or scattering the light emitted from the light source. These conventional handheld work lights include a focusing knob that is rotated to adjust the focus distance of the emitted light. Although it is possible with these types of conventional handheld work lights to accurately adjust the focus distance of the emitted light, the operation of the light focusing mechanism is inconvenient because the user is required to manually rotate the focusing knob by several turns and the focusing speed is relatively slow.

### SUMMARY

Embodiments of the invention generally relate to a work light, and more particularly, to a work light including a light focusing mechanism for focusing or scattering light emitted from the work light, whereby the light focusing mechanism includes a slide switch.

In particular, in accordance with an embodiment of the invention, there is provided a work light, which includes a housing, a light source including one of a light-emitting diode and a compact fluorescent light, and a light assembly including a plurality of light-emitting diodes. The work light further includes a power source, and a light focusing mechanism including a slide switch. The slide switch controls a focus distance of light emitted from the light source. The light focusing mechanism is configured to focus light emitted from the light source, when the slide switch is positioned in a first position, and configured to scatter light emitted from the light source, when the slide switch is positioned in a second position.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a perspective view of a work light, in accordance with an embodiment of the invention.

FIG. 2 is another perspective view of the work light, as shown in FIG. 1, in accordance with an embodiment of the invention.

FIG. 3 is an exploded view of the work light, as shown in FIG. 1, in accordance with an embodiment of the invention.

FIGS. 4a-c are perspective views of assemblies of the light focusing mechanism of the work light, as shown in FIG. 1, in accordance with an embodiment of the invention.

FIG. 5 is a perspective view of the work light, in accordance with another embodiment of the invention.

FIGS. 6a-6f are perspective views of the work light, in accordance with another embodiment of the invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. Prime notation, if used, indicates similar elements in alternative embodiments.

Embodiments of the invention generally relate to a work light, and more particularly, to a work light including a light focusing mechanism for focusing or scattering light emitted from the work light, whereby the light focusing mechanism includes a slide switch. The slide switch allows the user to conveniently adjust the focus distance of the emitted light from the work light. The work light, according to various embodiments, further includes a control switch configured to control an operation of both a light source and a light assembly. In accordance with other embodiments, the control switch is configured to only control an operation of the light source. The work light, according to various embodiments, further includes one or more attachment means for securing the work light to a surface, for example, to hang the work light or to secure the work light to a work surface.

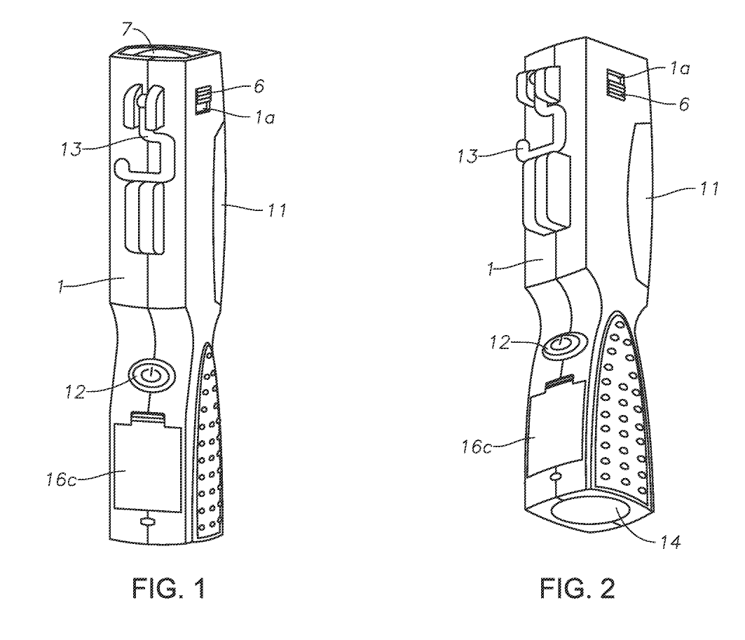

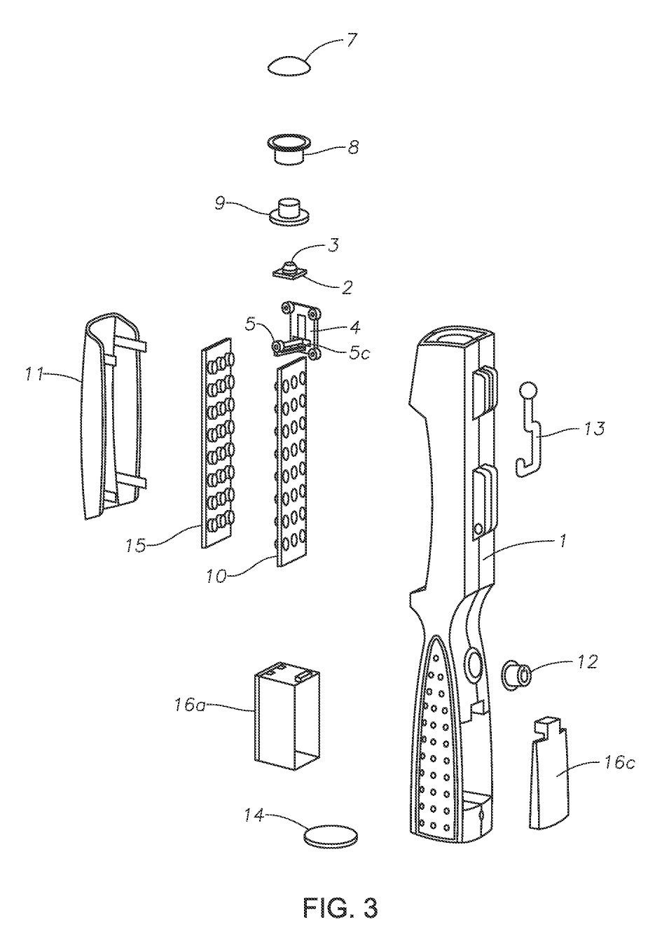

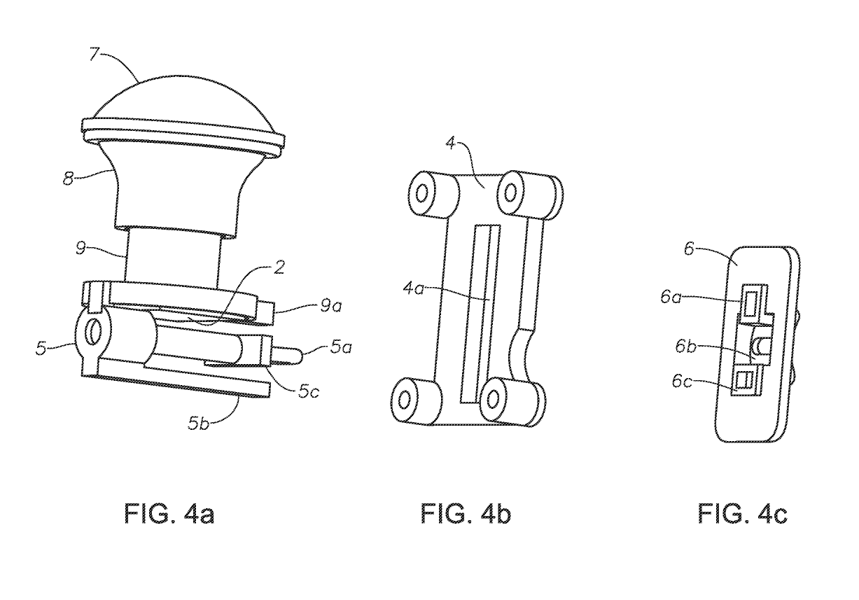

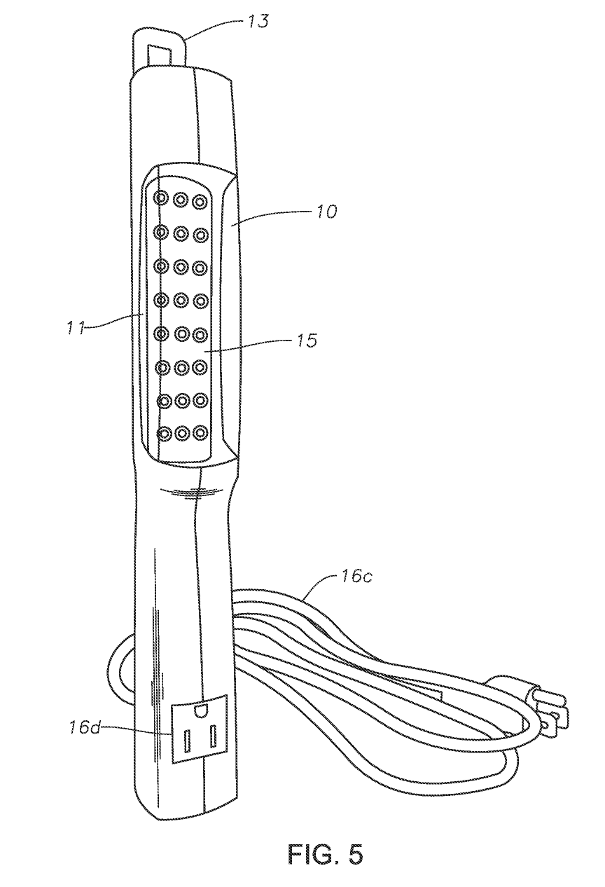

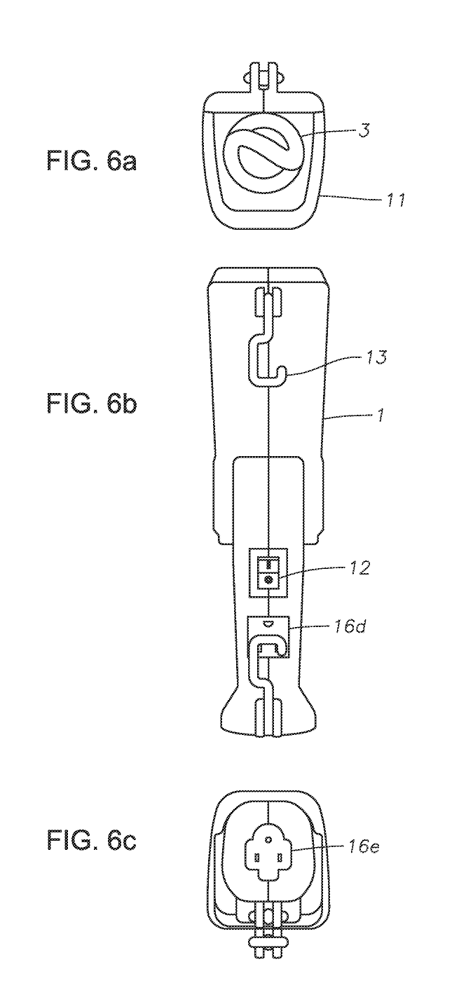

FIG. 1 is a perspective view of a work light, in accordance with an embodiment of the invention. FIG. 2 is another perspective view of the work light, as shown in FIG. 1, in accordance with an embodiment of the invention. FIG. 3 is an exploded view of the work light, as shown in FIG. 1, in accordance with an embodiment of the invention. FIGS. 4a-c are perspective views of assemblies of the light focusing mechanism of the work light, as shown in FIG. 1, in accordance with an embodiment of the invention. FIG. 5 is a perspective view of the work light, in accordance with another embodiment of the invention.

As shown in FIGS. 1-4a-c, the work light, according to various embodiments of the invention, includes a lamp housing 1, a light source 3, a light assembly 10, a power source 16, and a light focusing mechanism. According to at least one embodiment, the light source 3, the light assembly 10, and the power source 16 are arranged in a cavity of the lamp housing 1. As shown in FIG. 3, the light source 3 is arranged in an upper portion of the lamp housing 1, the light assembly 10 is arranged in a portion of the lamp housing 1 below the light source 3, and the power source 16 is arranged in a portion of the lamp housing 1 below the light assembly 10.

In accordance with an embodiment, the light source 3 includes a light-emitting diode (LED), and the light assembly 10 includes a plurality of LEDs, as shown in FIGS. 3 and 5. One of ordinary skill in the relevant art would have understood that the light source 3 could include a compact fluorescent light (CFL) as a replacement for the LED. As shown in FIGS. 3 and 5, the plurality of LEDs of the light assembly 10 is arranged in a longitudinal orientation, facing the front of the work light. In accordance with at least one embodiment, the light assembly 10 includes a reflective board 15. The lamp housing 1 includes a transparent shade 11 through which the light from the light assembly 10 is emitted. The power source 16 is coupled to the light source 3 and the light assembly 10, and powers the light source 3 and the light assembly 10, as will be discussed in more detail below. In accordance with certain embodiments, the power source 16 includes a battery case 16a, a battery (not shown), and a battery case cover 16b, as shown in FIGS. 1-3, while in other embodiments, the power source includes an AC electrical cord and plug 16c and an AC electrical socket 16d, as shown in FIG. 5. In accordance with at least one embodiment, a plurality of work lights are strung in series (not shown), whereby the AC electrical cord and plug 16c of a second work light is plugged into the AC electrical socket 16d of a first work light. Additional work lights are coupled in series using respective AC electrical cords and plugs 16c and respective AC electrical sockets 16d.

In accordance with certain embodiments, the lamp housing 1 includes a control switch 12 arranged on a back side wall of the lamp housing 1. The control switch 12 is coupled to the light source 3 and the light assembly 10. In operation, when the control switch 12 is pressed one time, the plurality of LEDs of the light assembly 10 is activated, while the LED of the light source 3 remains de-activated. When the control switch 12 is pressed a second time, the LED of the light source 3 is activated, while the plurality of LEDs of the light assembly 10 remain de-activated. When the control switch 12 is pressed a third time, the LEDs in both the light source 3 and the light assembly 10 are de-activated. One of ordinary skill in the relevant art would have understood that the operation of the control switch 12 could include any variation in the order of activation of the light source 3 and the light assembly 10, and the deactivation thereof. The control switch 12 includes one of a push button, a toggle switch, and a rocker switch, as non-limiting examples.

In accordance with certain embodiments, the work light includes a through-hole 1a bore in an upper portion of a side wall of the lamp housing 1. As shown in FIGS. 1 and 2, the through-hole 1a has a longitudinal shape or configuration. One of ordinary skill in the relevant art would have understood that other shapes or configurations could be used for the through-hole 1a.

The light focusing mechanism of the work light includes a mounting block 4 arranged at an upper portion of the side wall of the lamp housing 1 on an inner surface thereof. As shown in FIGS. 4b and 4c, the mounting block 4 includes a long hole 4a aligned with the through-hole 1a. In accordance with at least one embodiment, the long hole 4a has the same shape or configuration as the through-hole 1a.

The light focusing mechanism further includes a switch 6 coupled to an outer surface of the mounting block 4. In accordance with at least one embodiment, the switch 6 is a slide switch and includes a first slide portion 6a, a second slide portion 6b, and a third slide portion 6c. Each of the first slide portion 6a, the second slide portion 6b, and the third slide portion 6c includes a through-hole therein. As shown in FIG. 4c, the first slide portion 6a and the third slide portion 6c extend toward an interior of the lamp housing 1 and along a respective inner surface of the switch 6. The second slide portion 6b extends toward an exterior of the lamp housing 1 and through the through-hole 1a of the lamp housing 1 of the work light. In operation, when the second slide portion 6b of the switch 6 is positioned in a “down” position, the first slide portion 6a covers a portion of the through-hole 1a, such that the through-hole 1a is completely covered by first slide portion 6a and second slide portion 6b. When the second slide portion 6b is positioned in an “up” position, the third slide portion 6c covers a portion of the through-hole 1a, such that the through-hole is completely covered by second slide portion 6b and third slide portion 6c.

As shown in FIG. 4a, the light focusing mechanism further includes a drive mechanism, which includes a drive seat 5 and a lamp base 2 upon which the light source 3 is mounted. The drive seat 5 includes a first extension portion 5a and a second extension portion 5b, extending toward and through the long hole 4a in the mounting block 4 to engage the through-holes in the second slide switch 6b and the third slide switch 6c of the switch 6, respectively. The drive mechanism further includes a heat sink 9 arranged on a top surface of the lamp base 2 to improve heat dissipation from the light source 3. In accordance with at least one embodiment, the heat sink 9 includes an extension portion 9a extending toward and through the long hole 4a in the mounting block 4 to engage the through-hole in the first slide switch 6a of the switch 6. Accordingly, in assembly, the first and the second extension portions 5a, 5b of the drive seat 5 and the extension portion 9a of the heat sink 9 are coupled to the first, second, and third slide switches 6a, 6b, 6c of the switch 6, respectively. In operation, when the switch 6 is slid between an “up” position and a “down” position, the drive seat 5 and the heat sink 9 are driven simultaneously, thereby moving simultaneously the lamp base 2 and the light source 3 in relation to a position of a focusing lens 7.

As further shown in FIG. 4a, the drive seat 5 includes a stop block 5c arranged against an inner surface of the mounting block 4. As generally noted above, the outer surface of the mounting block 4 is arranged against the switch 6 in such a way that during manual operation of the switch 6, the switch 6 only has contact friction with the mounting block 4 and has no contact friction with the lamp housing 1 of the work light. Thus, when the switch 6, through extended use, begins to wear down due to abrasion with the mounting block 4, only the switch 6 and the mounting block 4 require replacement. The lamp housing 1, therefore, does not require replacement, effectively reducing the service cost associated with replacement of the lamp housing 1 and improving the durability of the work light.

As further shown in FIG. 4a, the focusing lens 7 is mounted on a lamp cup 8 affixed on a top surface of the lamp housing 1. In accordance with at least embodiment, the heat sink 9 protrudes upwards into the lamp cup 8. In operation, the manual movement of the switch 6 controls a distance between the light source 3 and the focusing lens 7 for adjusting the focus distance of the light source 3, thereby focusing or scattering the emitted light from the work light.

In accordance with certain embodiments, the work light further includes one or more attachment means for securing the work light to a surface, for example, to hang the work light or to secure the work light to a work surface. As shown in FIGS. 1-3 and 5, the lamp housing 1 of the work light includes a hook 13 arranged at an upper end of the lamp housing 1 on an outer back surface thereof for hanging the work light. The hook 13 is rotatably affixed to the lamp housing 1, allowing the hook 13 to be secured against the outer back surface of the lamp housing 1, when not in use. As shown in FIG. 3, the work light, according to an embodiment of the invention, includes a magnet 14 arranged in a bottom portion of the lamp housing 1 for securing the work light to a work surface (i.e., firmly standing on a workbench face during its operation).

Embodiments of the invention provide non-obvious advantages over conventional LED lamps. The work light, according to various embodiments, includes a light focusing mechanism for focusing or scattering light emitted from the work light, whereby the light focusing mechanism includes a slide switch. The slide switch allows the user to conveniently adjust the focus distance of the emitted light from the work light. The work light, according to various embodiments, further includes a control switch configured to control an operation of both a light source and a light assembly. The work light, according to various embodiments, further includes one or more attachment means for securing the work light to a surface, for example, to hang the work light or to secure the work light to a work surface.

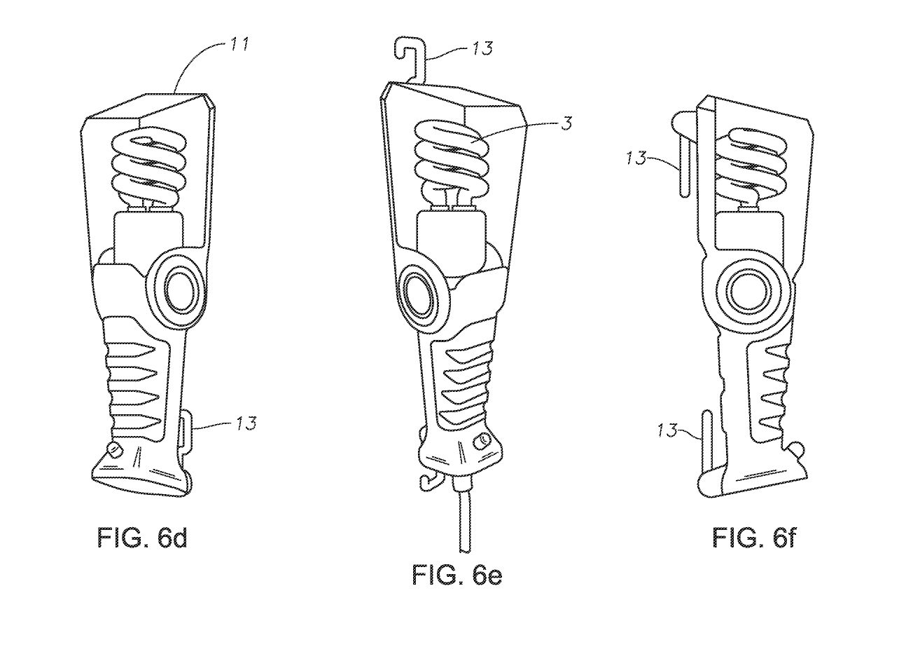

FIGS. 6a-6f are perspective views of the work light, in accordance with another embodiment of the invention. In accordance with at least one embodiment of the invention, as shown in FIGS. 6a-6f, the work light includes a light source 3 including a CFL. As further shown in FIGS. 6b-6f, the work light further includes a hook 13 arranged at a lower end of the lamp housing 1 on an outer back surface thereof for hanging the work light in an inverted position. As previously discussed, the hook 13 is rotatably affixed to the lamp housing 1, allowing the hook 13 to be secured against the outer back surface of the lamp housing 1, when not in use. In accordance with at least one embodiment, as further shown in FIGS. 6a-6f, the transparent shade 11 of the lamp housing 1 is arranged on a front surface, top surface, and side surfaces thereof. As further shown in FIG. 6c, the power source for the work light, in accordance with at least one embodiment, includes an AC electrical plug 16e embedded into a distal end of the lamp housing 1.

Embodiments of the present invention may suitably comprise, consist or consist essentially of the elements disclosed and may be practiced in the absence of an element not disclosed. For example, it can be recognized by those skilled in the art that certain steps can be combined into a single step.

Unless defined otherwise, all technical and scientific terms used have the same meaning as commonly understood by one of ordinary skill in the art to which this invention belongs.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

As used herein, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that the mere use of the term “first” and “second” does not require that there be any “third” component, although that possibility is contemplated under the scope of the embodiments of the present invention.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A work light, comprising:
a housing;
a light source comprising one of a light-emitting diode and a compact fluorescent light;
a light assembly comprising a plurality of light-emitting diodes;
a power source electrically coupled to the light source and the light assembly; and
a light focusing mechanism comprising a slide switch, the slide switch being configured to control a focus distance of light emitted from the light source,
wherein the light focusing mechanism is configured to focus light emitted from the light source, when the slide switch is positioned in a first position, and configured to scatter light emitted from the light source, when the slide switch is positioned in a second position.

2. The work light of claim 1, wherein the light source comprises the light-emitting diode.

3. The work light of claim 1, wherein the housing comprises a through-hole in an upper portion of a side wall of the housing,
the light focusing mechanism comprising
a mounting block arranged at the upper portion of the side wall of the housing on an inner surface thereof, the mounting block including a through-hole aligned with the through-hole of the housing, and
a drive mechanism coupled to the light source and the slide switch,
wherein the slide switch is configured to slide within the through-holes of the housing and the mounting block between a first position and a second position,
wherein, when the slide switch is moved between the first position and the second position, the drive mechanism moves the light source in relation to a position of a focusing lens for focusing or scattering the emitted light from the work light.

4. The work light of claim 3, wherein the slide switch comprises a first slide portion, a second slide portion, and a third slide portion, such that when the slide switch is moved between the first position and the second position, the first, second, and third slide portions are configured to cover the through-hole in the housing.

5. The work light of claim 3, wherein the drive mechanism comprises a drive seat including a first extension and a second extension, the first and second extensions being configured to engage through-holes in the second slide portion and the third slide portion of the slide switch, respectively, for coupling the drive mechanism to the slide switch.

6. The work light of claim 3, wherein the drive mechanism further comprises a heat sink configured to dissipate heat from the light source, the heat sink comprising an extension configured to engage a through-hole in the first slide portion of the slide switch for coupling the drive mechanism to the slide switch.

7. The work light of claim 5, wherein the drive seat further comprises a stop block arranged against an inner surface of the mounting block to control the movement of the slide switch within the through-hole of the mounting block.

8. The work light of claim 3, wherein the slide switch is arranged on an outer surface of the mounting block, such that the slide switch only has contact friction with the mounting block.

9. The work light of claim 1, wherein the light source, the light assembly, the power source, and the light focusing mechanism are arranged in a cavity of the housing.

10. The work light of claim 1, wherein the light source is arranged in an upper portion of the housing, the light assembly is arranged in a portion of the housing below the light source, and the power source is arranged in a portion of the lamp housing below the light assembly.

11. The work light of claim 1, wherein the power source comprises at least one of a battery, an AC electrical cord and plug, and an AC electrical socket.

12. The work light of claim 1, wherein the housing comprises a transparent shade through which light is emitted from at least one of the light source and the light assembly.

13. The work light of claim 1, further comprising:
a control switch operatively coupled to the light source and the light assembly, the control switch being configured to operate the light source and the light assembly either independently of one another or together.

14. The work light of claim 13, wherein the control switch comprises one of a push button, a toggle switch, and a rocker switch.

15. The work light of claim 1, further comprising:
an attachment means for securing the work light to a surface, the attachment means being rotatably affixed to the housing to secure the attachment means against a back surface of the housting when not in use.
